(19) United States
(12) Patent Application Publication
(10) Pub. No.: US 2018/0198492 A1
(43) Pub. Date: Jul. 12, 2018

(54) Antenna System with Feedline Conductors at Least Partially Traversing a Gap Between Open Ends of Arms

(71) Applicant: Motorola Mobility LLC, Chicago, IL (US)

(72) Inventors: Junsheng Zhao, Vernon Hills, IL (US); Hugh Smith, Palatine, IL (US); Haixia Liu, Xiamen (CN)

(21) Appl. No.: 15/839,775

(22) Filed: Dec. 12, 2017

(30) Foreign Application Priority Data
Jan. 10, 2017 (CN) 2017-10018219.8

(51) Int. Cl. H04B 5/00; H04M 1/737

(52) U.S. Cl. CPC H04B 5/0093; H04B 5/0037; H04M 1/737; H04B 5/0031

(57) ABSTRACT

The present application provides an antenna system for use in an electronic device. The antenna system includes a conductive substrate having a width, which corresponds to the distance between two opposite side edges of the conductive substrate proximate one end of the device. The antenna system further includes a pair of conductive arms, where each conductive arm in the pair of conductive arms has a connected end, which couples to the conductive substrate at alternative ones of the opposite side edges of the conductive substrate proximate the one end of the device. Each conductive arm further has an open end which extends away from the respective coupled side edge toward the other one of the opposite side edges in a direction of extension. The open ends of the conductive arms in the pair extend toward one another, stopping short of touching or overlapping the other conductive arm in the pair in the direction of extension away from the respective coupled side edge. Correspondingly, a gap is present between the respective open ends of the pair of conductive arms. A signal source is coupled to each of conductive arms proximate the respective open ends of the pair of conductive arms for supplying a signal. The signal source is coupled to at least one of the conductive arms via a respective feed line conductor, where the feed line conductor, that is coupled to the open end of the at least one of the pair of conductive arms, extends in the direction of extension which traverses at least a portion of the gap between the open ends of the conductive arms.

### FIELD OF THE APPLICATION

The present disclosure relates generally to electronic devices with an antenna system for supporting transmission and/or receipt of wireless energy, and more particularly, electronic devices incorporating an antenna system with a pair of conductive arms which extend from opposite side edges of a conductive substrate having open ends at which a signal source is applied, which stop short of touching or overlapping in the direction of extension.

### BACKGROUND

Near field communication, often abbreviated as NFC, refers to a short range wireless connectivity technology that enables convenient short-range communications between multiple devices, and/or a device and a tag. The communications often involve an inductive coupling which allows a signal to be conveyed between the two devices, and/or the device and the tag. More specifically, near field communications often involve magnetic induction between respective antennas located within each other's near field, such as respective loop antennas, which effectively form an air core transformer. In such an instance, a signal generated in a first communication element can be detected in the second communication element provided the two elements are in a compatible orientation, and are within relative close proximity, typically within 10 centimeters or less. In some instances, it may be possible for the two interacting devices to respectively supply and derive power through the inductive coupling, which can enable a device to read data out of a passive element including some forms of tags that do not otherwise have their own source of power. Many hand held electronic devices, such as cellular radio frequency communication devices have incorporated near field communication capabilities.

Near field communications have at least four primary operational modes of use: (1) card emulation mode; (2) tag reading; (3) tag writing; and (4) peer-to-peer. In turn, the near field communication elements can be used, for example, to enable users to use their near field communication equipped devices to support the communication of information, such as information in support of making a payment through touching or bringing their devices within proximity of a near field communication reader, in support of swapping contact information by touching or bringing their device within proximity of other near field communication equipped devices, and in support of unlocking their devices and/or in support of confirming the identity of the user by touching or bringing their device within proximity of a near field communication tag.

Given the proximity and interaction requirements of near field communications, and the need for the near field communication antennas to be integrated in a device with other electronic and mechanical components including user interface elements, the location and orientation of the near field communication elements with respect to the device can affect the relative performance and capabilities of the near field communication elements. The inclusion of near field communication capabilities in at least some hand held devices, such as cellular radio frequency communication devices, have generally followed one of two approaches. A first approach has incorporated a near field communication element toward the center of the back side surface of the device with an area of interaction proximate thereto, while a second approach has alternatively incorporated a near field communication element toward the top side surface of the device.

Each approach will generally have their own set of advantages and disadvantages in their convenience and performance when being used with various tags and readers including the manner in which the device can be conveniently held by the user to facilitate interaction with the other communication elements. For example, for a device having a near field communication element near the top surface of the device, by cupping the device within one's hand across the back of the device, one might more readily orient the device, such that the top of the device can be pointed toward a detection surface of a near field communication reader. However, the top of the device can commonly include other communication elements, such as one or more other antennas, which may need to share space with a near field communication antenna that is co-located at or near the top of the device. This can impact how one designs the various communication elements, as well as impact how the various communication elements function whether separately or together.

Alternatively, near field communication elements located toward the center of the back side surface of a device may make it easier to interact with a second device having a similarly located near field communication element, where it may be easier to hold the two devices together in back to back fashion in order to facilitate a transfer of data between the two devices via their respective near field communication elements. The position of the interacting near field communication element proximate the back surface will provide a different set of limitations, challenges and/or opportunities as to the nature and shape of the elements, which can be used to support near field communications. For example, supporting near field communications via an element located toward the backside surface, will often include a coil antenna backed by a sheet of high permeability material, such as a ferrite material through which the return magnetic fields can more readily flow. However, the coil antenna and any corresponding high permeability material will generally add to the thickness of the device. Such an arrangement will also benefit from a non-conductive back or a conductive back cover with one or more discontinuations, such as openings, voids, slits and/or slots.

The use of conductive materials, such as metals and/or alloys, in the support structure for the device have become increasingly desirable as the amount of space for material to support the structural integrity of the device has generally decreased. A trend toward less overall space for use in device structural support is a result of a trend toward a desire for a reduction in the overall size of many types of devices, while there has also been a separate trend toward simultaneously increasing the size of user interface elements, such as display screens which are increasingly supporting displaying more information as well as supporting touch interfaces, which in turn generally involve larger sized openings in the housing structure of the device. In addition to openings for user interface elements, such as display screens, further discontinuations in the device housing, i.e. openings, such as one or more slits in a conductive housing and/or a cover of the device for supporting wireless communications can further present a challenge relative to managing and maintaining the overall structural integrity of the device within the desired overall size constraints. In some instances, slits in a housing made of a conductive material could be used to form an area through which a wireless signal can propagate. In other instances, one or more slits in a housing made of a conductive material could be used to form and define a conductive element that can be used as part of a radiating structure. The further openings and/or cuts can also affect the aesthetics of the device. Furthermore, forming conductive structures for use in radiating a wireless signal within the constraints of elements similarly being used to provide structural support may not have sufficient flexibility to form desired overall structures relative to one or more portions of an antenna system.

The present innovators have recognized that by supplementing the antenna system with one or more conductive elements, such as portions of one or more signal feed lines, that can go beyond the constraints of elements formed as part of conductive housing and/or structure, the geometries of the antenna system can be better managed to produce a wireless signal having a more beneficial radiation and/or signal strength pattern.

### SUMMARY

The present application provides an antenna system for use in an electronic device. The antenna system includes a conductive substrate having a width, which corresponds to the distance between two opposite side edges of the conductive substrate proximate one end of the device. The antenna system further includes a pair of conductive arms, where each conductive arm in the pair of conductive arms has a connected end, which couples to the conductive substrate at alternative ones of the opposite side edges of the conductive substrate proximate the one end of the device. Each conductive arm further has an open end which extends away from the respective coupled side edge toward the other one of the opposite side edges in a direction of extension. The open ends of the conductive arms in the pair extend toward one another, stopping short of touching or overlapping the other conductive arm in the pair in the direction of extension away from the respective coupled side edge. Correspondingly, a gap is present between the respective open ends of the pair of conductive arms. A signal source is coupled to each of conductive arms proximate the respective open ends of the pair of conductive arms for supplying a signal. The signal source is coupled to at least one of the conductive arms via a respective feed line conductor, where the feed line conductor, that is coupled to the open end of the at least one of the pair of conductive arms, extends in the direction of extension which traverses at least a portion of the gap between the open ends of the conductive arms.

In at least one embodiment, the signal source is coupled to each of the conductive arms in the pair of conductive arms via a pair of respective feed line conductors, where each of the respective feed line conductors coupled to the open end of the respective one of the pair of conductive arms extends in the direction of extension which traverses at least a portion of the gap between the open ends of the conductive arms.

In at least a further embodiment, one or more of the respective feed line conductors traverse the gap between the open ends of the conductive arms, and in some of the same or other instances in addition to traversing the gap between the open ends of the conductive arms, one or more of the respective feed line conductors overlap at least a portion of the conductive arm not coupled to the respective feed line conductor along the direction of extension that the conductive arms extend towards one another away from the respective coupled side edge.

In at least a still further embodiment, the signal being supplied to the pair of conductive arms by the signal source includes a pair of respective signals that are substantially 180 degrees out of phase, and in some of the same or other instances the signal being supplied to the pair of conductive arms by the signal source includes a pair of respective signals that have an opposite polarity.

These and other features, and advantages of the present disclosure are evident from the following description of one or more preferred embodiments, with reference to the accompanying drawings.

### BRIEF DESCRIPTION OF THE DRAWINGS

FIG. 1 is a front view of an exemplary wireless communication device;

FIG. 2 is a rear view of an exemplary wireless communication device;

FIG. 3A is a partial schematic view of an antenna system associated with one end of an exemplary wireless communication device;

FIG. 3B is a graph of magnetic field strength as a function of a position along the width of the device associated with configuration included in the partial schematic view illustrated in FIG. 3A;

FIG. 4A is a partial schematic view of an antenna system associated with one end of an exemplary wireless communication device, in accordance with at least one embodiment of the present disclosure;

FIG. 4B is a graph of magnetic field strength as a function of a position along the width of the device associated with configuration included in the partial schematic view illustrated in FIG. 4A;

FIG. 5A is a partial schematic view of an antenna system associated with one end of an exemplary wireless communication device, in accordance with at least a further embodiment of the present disclosure;

FIG. 5B is a graph of magnetic field strength as a function of a position along the width of the device associated with configuration included in the partial schematic view illustrated in FIG. 5A;

FIG. 6 is a partial schematic view of an antenna system associated with one end of an exemplary wireless communication device, in accordance with at least a still further embodiment of the present disclosure; and

FIG. 7 is a partial internal view of an end of an exemplary wireless communication device including an antenna system having at least a first pair of conductive arms extending from a conductive substrate.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification and is not intended to limit the invention to the specific embodiments illustrated. One skilled in the art will hopefully appreciate that the elements in the drawings are illustrated for simplicity and clarity and have not necessarily been drawn to scale. For example, the dimensions of some of the elements in the drawings may be exaggerated relative to other elements with the intent to help improve understanding of the aspects of the embodiments being illustrated and described.

FIG. 1 illustrates a front view of an exemplary wireless communication device 100, such as a wireless communication device. While in the illustrated embodiment, the type of wireless communication device shown is a radio frequency cellular telephone, which incorporates near field communication capabilities, other types of devices that include wireless radio frequency communication including near field communication capabilities are also relevant to the present application. In other words, the present application is generally applicable to wireless communication devices beyond the type being specifically shown. A couple of additional examples of suitable wireless communication devices that may additionally be relevant to the present application in the incorporation and management of an antenna as part of the housing can include a tablet, a laptop computer, a desktop computer, a netbook, a cordless telephone, a selective call receiver, a gaming device, a personal digital assistant, as well as any other form of wireless communication device that might be used to manage wireless communications including one or more forms of near field communications.

In the illustrated embodiment, the radio frequency cellular telephone includes a display 102 which covers a large portion of the front facing. In at least some instances, the display can incorporate a touch sensitive matrix, that can help facilitate the detection of one or more user inputs relative to at least some portions of the display, including an interaction with visual elements being presented to the user via the display 102. In some instances, the visual element could be an object with which the user can interact. In other instances, the visual element can form part of a visual representation of a keyboard including one or more virtual keys and/or one or more buttons with which the user can interact and/or select for a simulated actuation. In addition to one or more virtual user actuatable buttons or keys, the device 100 can include one or more physical user actuatable buttons 104. In the particular embodiment illustrated, the device has three such buttons located along the right side of the device.

The exemplary hand held electronic device, illustrated in FIG. 1, additionally includes a speaker 106 and a microphone 108 in support of voice communications. The speaker 106 may additionally support the reproduction of an audio signal, which could be a stand-alone signal, such as for use in the playing of music, or can be part of a multimedia presentation, such as for use in the playing of a movie, which might have at least an audio as well as a visual component. The speaker may also include the capability to also produce a vibratory effect. However, in some instances, the purposeful production of vibrational effects may be associated with a separate element, not shown, which is internal to the device. Generally, the speaker is located toward the top of the device, which corresponds to an orientation consistent with the respective portion of the device facing in an upward direction during usage in support of a voice communication. In such an instance, the speaker 106 might be intended to align with the ear of the user, and the microphone 108 might be intended to align with the mouth of the user. Also located near the top of the device, in the illustrated embodiment, is a front facing camera 110. Still further, the top of the device can include one or more antennas, and in the present instance an antenna 112 for at least one form of near field communications will be present proximate the top of the device. Such a placement enables the device to interact with at least some near field communication readers by pointing the top of device toward and proximate to a reader.

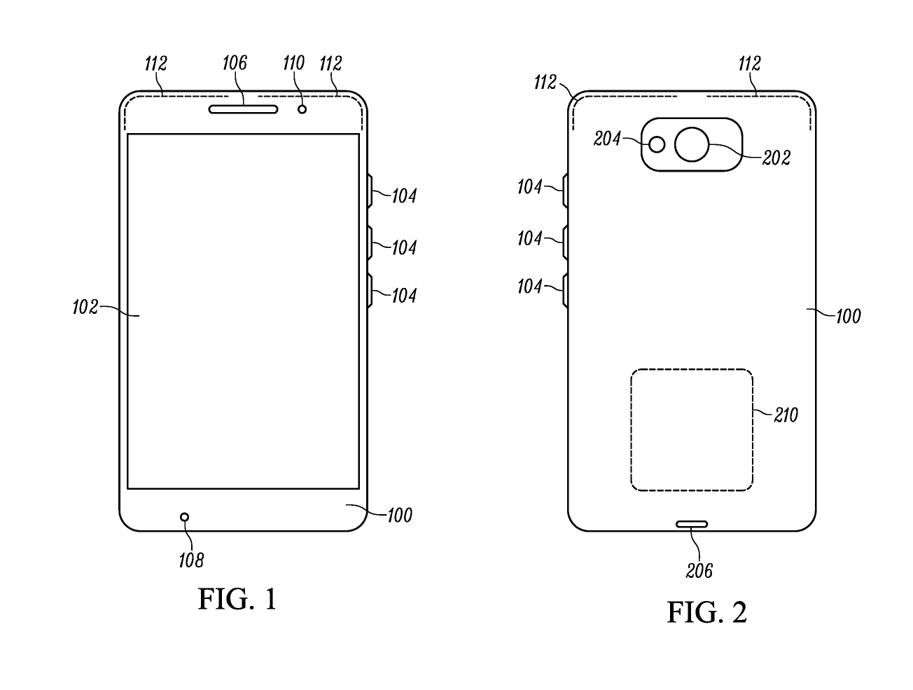

FIG. 2 illustrates a back view of the exemplary hand held electronic device 100, illustrated in FIG. 1. In the back view of the exemplary hand held electronic device, the three physical user actuatable buttons 104, which are visible in the front view, can similarly be seen. The exemplary hand held electronic device additionally includes a back side facing camera 202 with a flash 204, as well as a serial bus port 206, which is generally adapted for receiving a cable connection, which can be used to receive data and/or power signals. In addition to the antenna 112 located proximate the top of the device, which is capable of supporting at least one form of near field communications, in some instances a still further area 210 proximate the back side surface of the device 100 can include a loop antenna including one or more loops, which are similarly capable of supporting one or more forms of near field communications, as well as potentially being used to support wireless charging. Such a loop antenna, when present, is often located within the device just below the back side surface of the device 100.

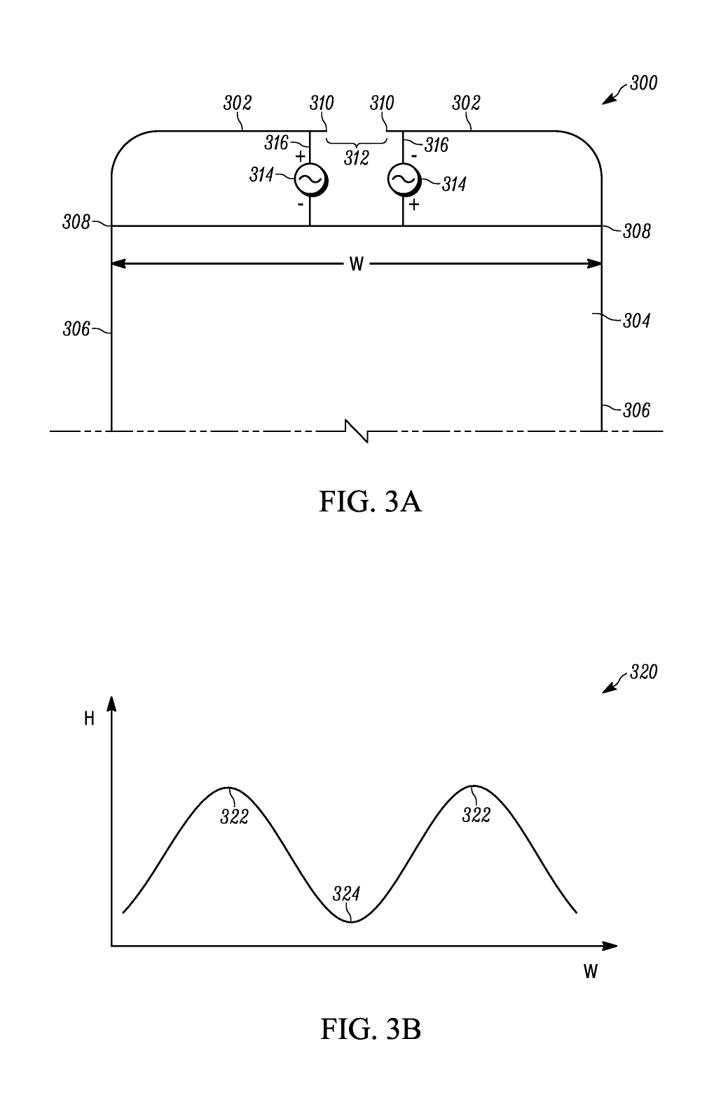

FIG. 3A illustrates a partial schematic view 300 of an antenna system associated with one end of an exemplary wireless communication device 100. In the illustrated example, the antenna system includes a plurality of arms 302, which extend from a substrate 304. More specifically, in the illustrated example, the substrate 304 has a width, w, which is often related to the width of the device 100, where the side edges 306 of the substrate 304 will each generally correspond to respective side edges of the device 100. In the illustrated example, one end 308 of each of the arms 302 is coupled to the substrate 304 at or near a respective one of the side edges 306 of the substrate 304. Each of the arms 302 then extend along their length away from the substrate 304 and toward the other one of side edges 306 that the arm 302 is not coupled. Generally a pair of related arms 302 will extend toward one another from their respective side edge 306 to which the arms are coupled. The arms 302 will end at an open end 310 at a point that generally stops short of touching or overlapping the other arm 302. Correspondingly, when the open ends 310 of the related pair of arms 302 stop short of touching or overlapping, a gap 312 is present between the open ends 310 of the arms 302.

One or more signals associated with one or more signal sources 314 are respectively coupled to each of the arms 302 at or near the open ends 310 of each of the arms 302. In the illustrated example, the arms 302 form an antenna structure capable of receiving radiated energy and/or detecting a magnetic field at a compatible frequency. In combination with the signal source(s) 314, the same antenna structure is further capable of transmitting a radiated energy signal and/or producing a magnetic field at a compatible frequency. In at least the illustrated example, the signal being coupled to each of the respective ends will have a similar amplitude and frequency, but an opposite polarity. In at least one instance, the antenna system will support near field communications having a frequency of 13.56 MHz.

In some instances, portions of the substrate may be associated with the device housing and/or internal support structure, such as a frame or chassis for the overall device and/or for one or more of the components, which can be formed using a conductive material, such as a metal and/or a metal alloy. In some instances, the substrate can additionally and/or alternatively incorporate portions of a circuit substrate, such as a printed circuit substrate, which can include conductive planes and/or traces for making one or more electrical connections, and/or a conductive circuit shield. The circuit substrate can also be used to receive electrical elements including electronic circuitry, components and/or modules.

In at least some instances, the arms are associated with the sidewall of an exterior of a metal housing, where portions of the arms, extending along its length away from the coupled end, are isolated from the rest of the housing structure. In the illustrated example, the arms extend away from substrate near the top of the device. The arms make a turn proximate the corner of the device 100, and extend back toward the center of the top surface of the device, away from the side edges. Openings can exist in the sidewall, which allows for the formation of arms, as well as the inclusion of features such as the placement of physical user actuatable buttons 104, as well as various other porting such as a headphone jack, microphone ports, and memory card slots. In some instances, some of the openings, such as the openings which define the shape of the arms 204, can be filled in with a nonconductive material such as a plastic type material.

In the example illustrated in FIG. 3A, the corresponding signal source 314 is coupled to the open end 310 of the respective arm 302 via a feed line 316 that generally does not extend beyond the open end of the respective arms toward or into the area associated with the gap 312. Such a configuration results in a field strength pattern that has two discernible peaks 322 with a pronounced valley 324 between the two peaks 322. An example of a corresponding field strength pattern can be seen in FIG. 3B. More specifically, FIG. 3B illustrates a graph 320 of magnetic field strength, often measured in amperes per meter, as a function of a position along the width of the device associated with the configuration included in the partial schematic view illustrated in FIG. 3A.

Such a field strength pattern can sometimes be problematic in so far as the field strength is weaker proximate the gap 312, which often generally corresponds to the center of the top surface. When a user points the device 100 at a reader, the user will typically point relative to the center of the top of the device 100. In this arrangement the field strength is weaker in the center and stronger as one moves slightly off center in either direction. However, the inventors have recognized that the field strength pattern can be further affected by adjusting the geometry of the feed lines 316 relative to the gap 312 between the open ends of the two arms 302.

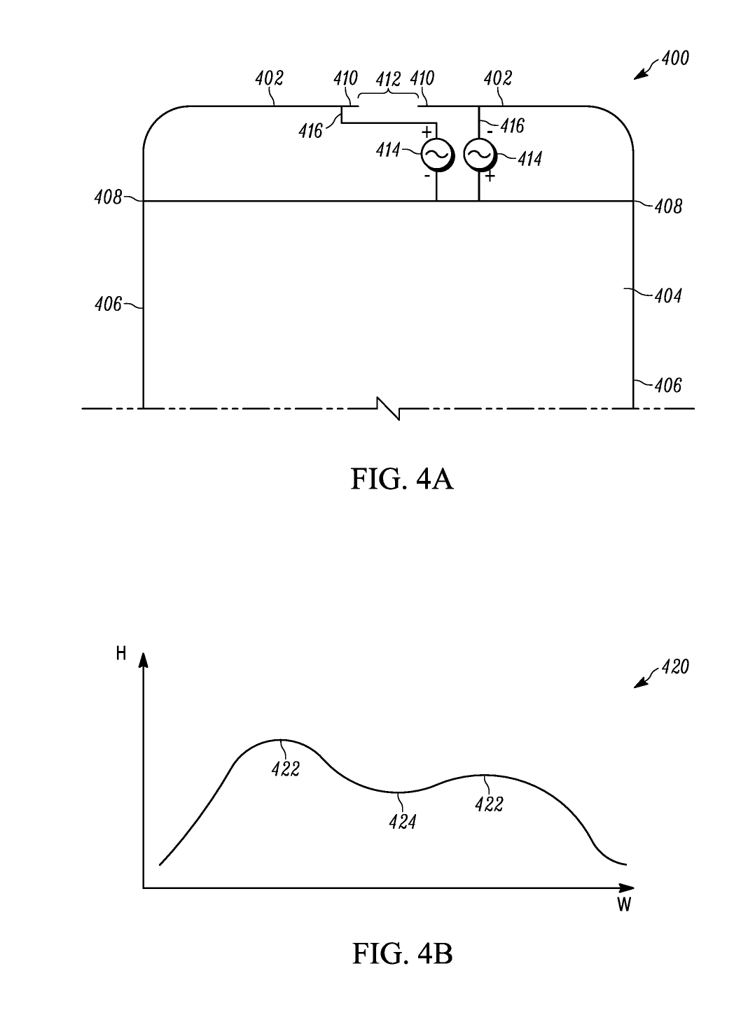

FIG. 4A illustrates a partial schematic view 400 of an antenna system associated with one end of an exemplary wireless communication device 100, in accordance with at least one embodiment of the present disclosure. The present embodiment includes a pair of conductive arms 402 each extending from a respective one of the two side edges 406 of a conductive substrate 404, in a manner that is similar to the two arms 302, illustrated in FIG. 3A.

One end 408 of each of the arms 402 is coupled to the substrate 404 at or near a respective one of the side edges 406 of the substrate 404. Each of the arms 402 then extend along their length away from the substrate 404 and toward the other one of side edges 406 that the arm 402 is not coupled. Generally a pair of related arms 402 will extend toward one another from their respective side edge 406 to which the arms are coupled. The arms 402 will end at an open end 410 at a point that generally stops short of touching or overlapping the other arm 402, resulting in a gap 412 being present.

One or more signals associated with one or more signal sources 414 are respectively coupled to each of the arms 402 at or near the open ends 410 of each of the arms 402. The corresponding signal source 414 is coupled to the open end 410 of the respective arm 402 via a feed line 416. However in this instance, one of the feed lines 416 extends beyond the respective open end 410 of the arm 402 into at least the gap area 412 between the open ends 410. By allowing at least one of the feed lines 416 to extend into the gap area 412 between the open ends 410, the resulting magnetic field strength pattern does not exhibit as pronounced of a decrease or valley 424 between the two peaks 422, as shown in FIG. 4B, which corresponds to a graph 420 of magnetic field strength as a function of a position along the width of the device associated with the configuration included in the partial schematic view illustrated in FIG. 4A. This helps to smooth out the magnitude of the magnetic field strength more proximate the center of the top surface of the device 100.

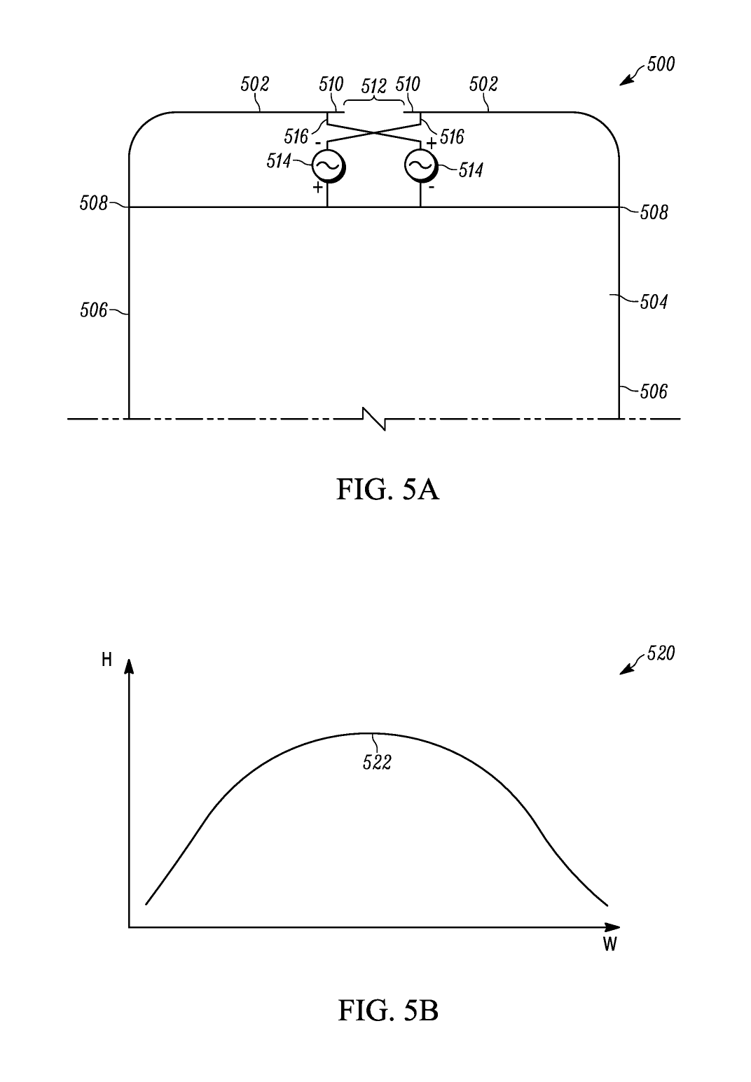

FIG. 5A illustrates a partial schematic view 500 of an antenna system associated with one end of an exemplary wireless communication device 100, in accordance with at least a further embodiment of the present disclosure. The present embodiment includes a pair of conductive arms 502 each extending from a respective one of the two side edges 506 of a conductive substrate 504, in a manner that is similar to the two arms 302 and 402, illustrated respectively in each of FIG. 3A and FIG. 4A.

One end 508 of each of the arms 502 is coupled to the substrate 504 at or near a respective one of the side edges 506 of the substrate 504. Each of the arms 502 then extend along their length away from the substrate 504 and toward the other one of side edges 506 that the arm 502 is not coupled. Generally a pair of related arms 502 will extend toward one another from their respective side edge 506 to which the arms are coupled. The arms 502 will end at an open end 510 at a point that generally stops short of touching or overlapping the other arm 502, resulting in a gap 512 being present.

One or more signals associated with one or more signal sources 514 are respectively coupled to each of the arms 502 at or near the open ends 510 of each of the arms 502. The corresponding signal source 514 is coupled to the open end 510 of the respective arm 502 via a feed line 516. However in this instance, both of the feed lines 516 extend beyond the respective open end 510 of the arm 502 into at least the gap area 512 between the open ends 510. By allowing both of the feed lines 516 to extend into the gap area 512 between the open ends 510, the resulting magnetic field strength pattern exhibits even less of a decrease between any peaks, as shown in FIG. 5B, to the point that in at least some instances a decrease will no longer exist, and the resulting pattern will have more of a single peak 522 more closely centered relative to the overall width of the top surface. More specifically, FIG. 5B illustrates a graph 520 of magnetic field strength as a function of a position along the width of the device associated with the configuration included in the partial schematic view illustrated in FIG. 5A.

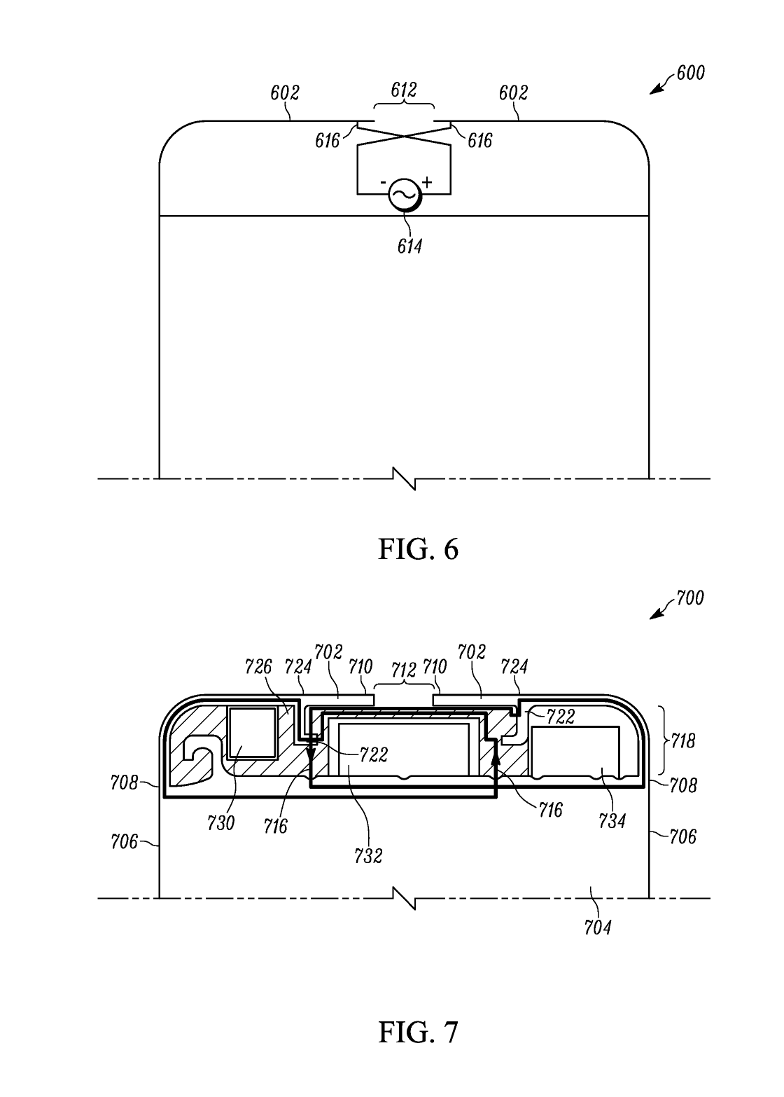

FIG. 6 illustrates a partial schematic view 600 of an antenna system associated with one end of an exemplary wireless communication device 100, in accordance with at least a still further embodiment of the present disclosure. In the present embodiment, the arrangement of feed lines 616 relative to a gap 612 between the open ends of a pair of arms 602 is similar to the embodiment illustrated in FIG. 5A. However, because of the desired difference in polarity of the drive signals, where the signals being coupled to the arms 602 are otherwise similar, it may be possible to couple a single signal source 614 across both of the feed lines 616. Such an arrangement would better insure the application of a signal having a similar frequency, as well as accommodate a signal being applied to the arms 602 via the respective feed lines 616, which have an opposite polarity.

FIG. 7 illustrates a partial internal view 700 of an end of an exemplary wireless communication device 100 including an antenna system having at least a first pair of conductive arms 702, which extend from a conductive substrate 704 proximate one end of the device 100. Similar to the schematic views illustrated in FIGS. 3A-6A, the conductive arms 702 each extend from a respective one of the two side edges 706 of a conductive substrate 704 a distance 718 away from the main body of the substrate. In the illustrated embodiment, each of the arms 702 have a protrusion 722 that branches away from the arm 702 at a point 724 along its length between its open end 710 and the end 708 that is coupled to the substrate 704. In some instances, the protrusions 722 can be integrally formed with the rest of the arms 702. In other instances, the protrusions 722 can be separately formed and attached.

In the space between the arms 702 and the substrate 704 a circuit substrate 726 can be positioned. In the illustrated embodiment, the circuit substrate 726 is identified with a cross hatch. The cross hatch is intended to more clearly identify a different element, and is not intended to indicate an exposed internal surface associated with a cut away view. More specifically, the circuit substrate 726 can be a printed circuit substrate upon which electrical elements including electronic circuitry, components and/or modules can be received, and within which electrical traces can be formed. In the illustrated embodiment, the feed lines 716, which can be used for coupling a signal source to the arms 702 are at least partially formed as traces on the circuit substrate 726. In the illustrated embodiment, the feed lines 716 also couple to the arms via the protrusions 722. Together the feed lines 716, arms 702, as well as at least partially a return current path through substrate 704 can form respective overlapping current loops, which extend across the gap 712 in a manner where the current across the gap from the two loops are additive, and which in turn help produce an electromagnetic signal, that helps to avoid a degradation in strength near the gap between the ends of the arms 702. Furthermore, mechanical elements and/or electronic circuit elements are also visible in the partial internal view 700. For example, an imager 730, a speaker 732, and a sim card tray 734 are also at least partially visible.

In addition to supporting near field communications, the antenna system could also support the transmission and reception of other forms of communications, including the transmission and reception of a cellular radio frequency communication, including signal diversity, as well as GPS and WiFi type signals. The support for coupling the multiple types of signaling, each often associated with a different set of frequencies, to the arms of the antenna system can be supported by one or more diplexing circuits, which are not shown.

While the preferred embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. An antenna system for use in an electronic device, the antenna system comprising:
a conductive substrate having a width, which corresponds to the distance between two opposite side edges of the conductive substrate proximate one end of the device;
a pair of conductive arms, where each conductive arm in the pair of conductive arms has a connected end, which couples to the conductive substrate at alternative ones of the opposite side edges of the conductive substrate proximate the one end of the device, and an open end which extends away from the respective coupled side edge toward the other one of the opposite side edges in a direction of extension, where the open ends of the conductive arms in the pair extend toward one another, stopping short of touching or overlapping the other conductive arm in the pair in the direction of extension away from the respective coupled side edge, thereby forming a gap between the respective open ends of the pair of conductive arms;
a signal source coupled to each of conductive arms proximate the respective open ends of the pair of conductive arms for supplying a signal, wherein the signal source is coupled to at least one of the conductive arms via a respective feed line conductor, where the feed line conductor coupled to the open end of the at least one of the pair of conductive arms extends in the direction of extension which traverses at least a portion of the gap between the open ends of the conductive arms.

2. An antenna system in accordance with claim 1, wherein the respective feed line conductor traverses the gap between the open ends of the conductive arms.

3. An antenna system in accordance with claim 2, wherein in addition to traversing the gap between the open ends of the conductive arms, the respective feed line conductor overlaps at least a portion of the conductive arm not coupled to the respective feed line conductor along the direction of extension that the conductive arms extend towards one another away from the respective coupled side edge.

4. An antenna system in accordance with claim 1, wherein the signal source is coupled to each of the conductive arms in the pair of conductive arms via a pair of respective feed line conductors, where each of the respective feed line conductors coupled to the open end of the respective one of the pair of conductive arms extends in the direction of extension which traverses at least a portion of the gap between the open ends of the conductive arms.

5. An antenna system in accordance with claim 4, wherein each of the respective feed line conductor traverses the gap between the open ends of the conductive arms.

6. An antenna system in accordance with claim 5, wherein in addition to traversing the gap between the open ends of the conductive arms, each of the respective feed line conductors overlaps at least a portion of the conductive arm not coupled to the respective feed line conductor along the direction of extension that the conductive arms extend towards one another away from the respective coupled side edge.

7. An antenna system in accordance with claim 1, wherein the two side edges of the conductive substrate are each respectively associated with a corresponding edge of the electronic device.

8. An antenna system in accordance with claim 1, wherein the conductive substrate includes at least part of a ground plane of a circuit substrate.

9. An antenna system in accordance with claim 1, wherein the pair of conductive arms are located at or near a top of a housing for the electronic device.

10. An antenna system in accordance with claim 9, wherein the housing of the electronic device is conductive and the pair of conductive arms are formed as part of the conductive housing.

11. An antenna system in accordance with claim 9, further comprising a second pair of conductive arms located at or near a bottom of the housing for the electronic device.

12. An antenna system in accordance with claim 1, wherein at least part of one or more of the feed line conductors are conductive traces formed as part of a circuit substrate.

13. An antenna system in accordance with claim 1, wherein the signal being supplied to the pair of conductive arms by the signal source includes a pair of respective signals that are substantially 180 degrees out of phase.

14. An antenna system in accordance with claim 1, wherein the signal being supplied to the pair of conductive arms by the signal source includes a pair of respective signals that have an opposite polarity.

15. An antenna system in accordance with claim 1, wherein each of the respective conductive arms and any associated feed line conductor, in addition to the conductive substrate, form a loop.

16. An antenna system in accordance with claim 15, wherein each of the loops occupy a portion of a window located between a top edge of the conductive substrate and the pair of conductive arms.

17. An antenna system in accordance with claim 15, wherein when the signal being supplied to each of the pair of conductive arms is supplied via a respective feed line conductor, and the respective feed line conductors overlap, the respective conductive arms, the associated feed lines, and the conductive substrate each form a respective loop, which at least partially overlaps with the other one of the respective loops.

18. An antenna system in accordance with claim 17, wherein the signal being supplied to the pair of conductive arms by the signal source includes a pair of respective signals that are of an opposite polarity, so as to produce a current in the overlapping portions of the respective feed line conductors, that flow in the same direction.

19. An antenna system in accordance with claim 1, wherein the antenna system is adapted for producing a wireless near field communication signal.

20. A antenna system in accordance with claim 1, wherein the electronic device is a hand held cellular radiotelephone.
